(19) United States
(12) Patent Application Publication
(10) Pub. No.: US 2026/0351482 A1
(43) Pub. Date: Nov. 5, 2026

(54) Optocoupled Variable Capacitor

(71) Applicant: Swaresh Borse, Allen, TX (US)

(72) Inventor: Swaresh Borse, Allen, TX (US)

(73) Assignee: Swaresh Borse, Allen, TX (US)

(21) Appl. No.: 19/197,959

(22) Filed: May 2, 2025

(51) Int. Cl. H01G 7/00; H01G 17/00

(52) U.S. Cl. CPC H01G 7/00; H01G 17/00

(57) ABSTRACT

The present invention is an electronic circuit comprised of photodiodes and a fixed ceramic disc capacitors optically coupled with a LED and zener diode to form a voltage/current controlled variable capacitor. Said invention has input and output isolated from each other which makes it ideal for circuits that required a variable capacitance without impacting original circuitry. Said assembly of photodiodes and a fixed ceramic disc capacitor forms a light dependent variable capacitor. Coupling said light dependent variable capacitor with a LED inside an optically isolated enclosure makes said invention function in a controlled environment. A zener diode is connected in parallel to said LED to prevent said invention from running into light saturation mode. Said invention can be implemented in applications that require a variable capacitor such as signal filters, tuning circuits, oscillators, etc.

### CROSS REFERENCE TO RELATED APPLICATIONS

This application does not provide reference to any prior applications.

### BACKGROUND OF THE INVENTION

### 1. Field of Invention

Capacitors, in general, are a vital part of electronic circuitry and they play crucial role in AC as well as DC circuits. Their ability to store electric charge is the fundamental principle of their operation. Present invention relates to light dependent capacitors that are variable in nature and the value of which depends on intensity of incident light. Said invention can be implemented in various electronic applications such as oscillators, filters, tuners, etc.

### 2. Description of Related Art

Said invention is an extension of a light dependent variable capacitor wherein said light dependent variable capacitor is coupled with a LED (Light Emitting Diode). The advantage of such a construction is that said variable capacitor can now be controlled by voltage and/or current and not by ambient light. Said invention is built in an optically enclosed container to prevent surrounding light to impact value of said light dependent variable capacitor. The only source of light impacting the capacitance value of said light dependent variable capacitor is the said LED which is controlled by external power supply source. Changes in voltage and/or current supply to said LED cause proportional capacitance value changes of said light dependent variable capacitor. Said invention implements two photodiodes, one fixed capacitor, one LED, and one zener diode all of which are enclosed in an optically opaque container.

### SUMMARY OF THE INVENTION

The present invention is a light-dependent capacitor coupled with a LED that provides a wide range of capacitance values controlled by applied voltage and/or current. The stronger the supplied power the more the intensity of light emitted by said LED and in turn the more value of capacitance provided by said invention. Said invention's working principle is primarily based on photo-diode operation. Any diode connected in a reverse biased configuration can function as a capacitor. A photodiode when connected in reverse biased configuration can be made to function as a variable capacitor whose value changes with changes in incident light intensity. Said invention is implemented by connecting two photodiodes in series with each other in a way that either they form a cathode-to-cathode connection or an anode-to-anode connection. This series connection is then connected in parallel with a ceramic disc capacitor. Said ceramic disc capacitor is required for practical implementation of said invention. Said LED is implemented in close physical proximity or said photodiodes to influence the value of capacitance of said photodiodes. A zener diode is connected in parallel to said LED in reverse biased configuration.

### BRIEF DESCRIPTION OF INVENTION DRAWINGS

FIG. 1. Functioning of variable capacitor

FIG. 2 Working principle of photodiode

FIG. 3. Common anode circuit diagram

FIG. 4. Common cathode circuit diagram

FIG. 5. Invention circuit diagram

FIG. 6. Voltage v/s capacitance graph

FIG. 7. Current v/s capacitance graph

### DETAILED DESCRIPTION OF INVENTION

The present invention uses a combination of working principles of diodes and capacitors. A variable capacitor can be implemented by changing the distance between a capacitor's conductive plates. A photodiode's depletion region size can be changed by variation in light intensity of the incident light. This change in depletion region causes a photodiode to function like a variable capacitor when reverse biased. Any diode has a parasitic capacitance at its junction. Said parasitic capacitance of said photodiode is leveraged to function as a variable capacitor by controlling the light incident on its junction. A LED is used as a controlled light source to modify said parasitic capacitance of said photodiode.

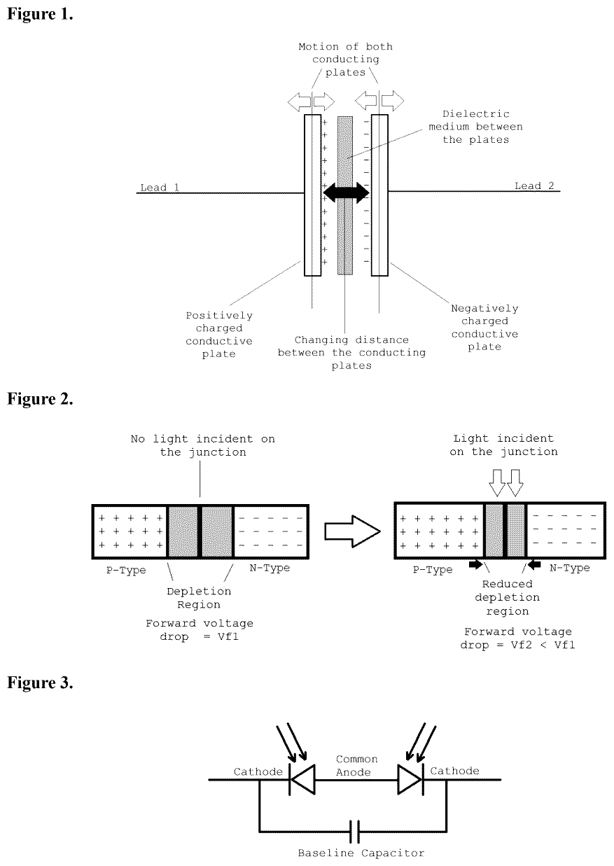

A simple capacitor consists of two conductive plates separated by a dielectric medium. One of the two said conductive plates is positively charged and the other is negatively charged. Upon changing the distance between these two plates the capacitance value of said capacitor changes. FIG. 1 in invention drawings illustrates this phenomenon. There are other factors that impact the value of capacitor such as surface area overlap of said conductive plates or dielectric constant of the insulator used. However, said invention is based on changes in capacitance due to change in distance between the two conductive plates.

A photodiode is a P-N junction semiconductor device that has depletion region exposed to light. Like any semiconductor diode, the P-N junction of said photodiode forms a depletion region. Due to said depletion region, diodes have a forward voltage drop. The size of the depletion region and its forward voltage drop at any given instance in time depends on intensity of light incident on the junction. FIG. 2 in invention drawings show the change in size of the depletion region. The more light falling on said P-N junction, the less the size of the depletion region gets and said forward voltage drop reduces.

Any semiconductor P-N junction diode can function as a capacitor when connected in a revers biased configuration. This capacitance is the result of said depletion region existing between a P-type semiconductor region and an N-Type semiconductor region. Said depletion region acts as a dielectric separating two conductive plates (P-Type semiconductor region and N-type semiconductor region). When light is incident on said P-N junction of a photodiode, the depletion region reduces which can be understood as reducing distance between said two conductive plates (P-type and N-type regions). This in turn increases the value of said parasitic capacitance.

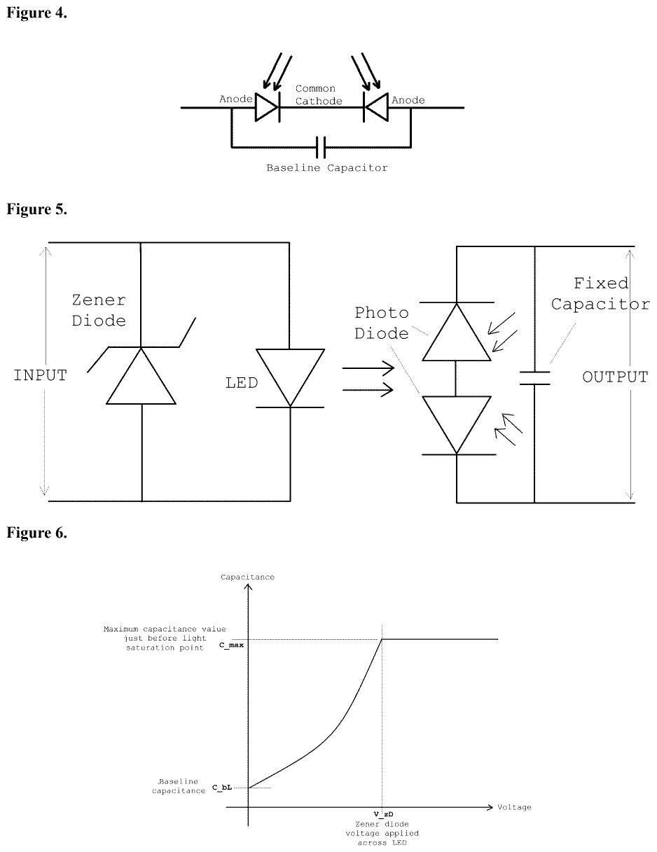

Said invention is constructed by connecting two photodiodes in series with each other and parallel to a ceramic disc capacitor. They can be connected in a common anode or common cathode configuration. FIG. 3 of invention drawings shows such a construction in a common anode configuration and FIG. 4 of invention drawings shows common cathode configuration. Utilizing two photodiodes in series with a common anode or common cathode configuration eliminates the requirement to operate said photodiode in reverse biased condition only. This makes said invention non-polar in nature. A ceramic disc fixed value capacitor connected in parallel to the above setup helps implement said invention in practical applications. Said fixed capacitor is termed as baseline capacitor. This setup is coupled with a LED and a zener diode in parallel to provide a controlled source of incident light. Said zener diode is required to prevent said invention from running into ‘light saturation point’.

The effective capacitance of said invention constructed in above said way at a given instance is given by the following equation:

C_{T}=[[Cₚ₁*Cₚ₂]/[Cₚ₁+Cₚ₂]]+C_{bl} (i)
Where,
C_{T}: Effective instantaneous capacitance of said invention
Cₚ₁: Instantaneous parasitic capacitance of photodiode 1 [FIG. 4 in invention drawings]
Cₚ₂: Instantaneous parasitic capacitance of photodiode 2 [FIG. 4 in invention drawings]
C_{bl}: Fixed ceramic disc capacitor (baseline capacitor)

When light from said LED is incident on said photodiodes, their parasitic capacitance changes according to the intensity changes of said LED incident light, there by changing the effective capacitance (CT in equation (i) above) of said invention.

FIG. 5 of invention drawings is a complete circuit diagram of Said invention wherein said photodiodes are connected in common anode configuration with said baseline capacitor in parallel, coupled with LED in parallel with said zener diode use for light saturation protection.

As intensity of light incident on said invention increases, said depletion regions of photodiodes used in building said invention decreases. As intensity of said incident light further continues to increase, said depletion regions of both said photodiodes continues to reduce. A point comes where said depletion region becomes so thin that it ceases to exist and hence no said parasitic capacitance of said photodiodes exists. Said invention operates in a variable resistance mode. This intensity of light incident upon said invention is termed as ‘Light Saturation Point’ beyond which further increase in intensity of said incident light makes said invention operate in resistive mode. To prevent driving said invention in resistive mode of operation, said zener diode is connected in parallel across said LED to limit flow of current through said LED thus preventing said invention from running into light saturation point.

FIG. 6 of invention drawings is a graph of output capacitance against input voltage of said invention which illustrates changes in capacitance of said invention at the output as applied voltage changes at the input. It shows said output capacitance goes on increasing from a baseline capacitance value point to a maximum capacitance value point as said applied voltage increases. Said maximum capacitance value point is a point just before said invention could run into said light saturation point. Beyond this point, as said applied voltage increases said output capacitance value of said invention remains constant. The said baseline capacitance value point is the value of said fixed capacitor (baseline capacitor) which is connected in parallel to said series connection of said photodiodes. Even with no incident light, said invention will operate at a minimum of said baseline capacitance value.

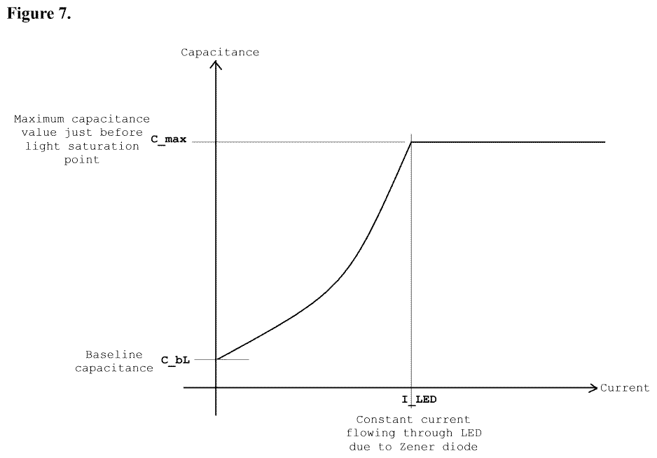

FIG. 7 of invention drawings is a graph similar to FIG. 6 of invention drawings wherein output capacitance of said invention is plotted against applied input current. It shows said output capacitance goes on increasing from said baseline capacitance value point to a maximum capacitance value point as said applied current increases. Beyond said maximum capacitance value point as said applied current increases, said output capacitance value of said invention remains constant.

The invention claimed is:

1. An assembly comprising:
a circuit built with two photodiodes wherein anode terminal of one of said photodiodes is connected to anode terminal of second one of said photodiodes, one fixed capacitor with two terminals wherein cathode terminal of one of said photodiodes is connected to one of said terminals of said fixed capacitor and cathode terminal of second one of said photodiodes is connected to said second terminal of said fixed capacitor; and
a circuit built with one LED and one zener diode wherein anode terminal of said LED is connected to cathode terminal of said zener diode and cathode terminal of said LED is connected to anode terminal of said zener diode.

2. An assembly comprising:
a circuit built with two photodiodes wherein cathode terminal of one of said photodiodes is connected to cathode terminal of second one of said photodiodes, one fixed capacitor with two terminals wherein anode terminal of one of said photodiodes is connected to one of said terminals of said fixed capacitor and anode terminal of second one of said photodiodes is connected to said second terminal of said fixed capacitor; and
a circuit built with one LED and one zener diode wherein anode terminal of said LED is connected to cathode terminal of said zener diode and cathode terminal of said LED is connected to anode terminal of said zener diode.
